(19) United States
(12) Patent Application Publication
(10) Pub. No.: US 2021/0199626 A1
(43) Pub. Date: Jul. 1, 2021

(54) FAST TEMPERATURE RAMP GAS CHROMATOGRAPHY

(71) Applicant: Pulmostics Limited, Dublin (IE)

(72) Inventor: Yin Sun, Bridgewater, NJ (US)

(21) Appl. No.: 17/201,822

(22) Filed: Mar. 15, 2021

Related U.S. Application Data
(63) Continuation of application No. 16/992,576, filed on Aug. 13, 2020, now abandoned.
Application No. 16/992,576 is a continuation of application No. 15/987,540, filed on May 23, 2018, now abandoned.
(60) Provisional application No. 62/511,768, filed on May 26, 2017.

(51) Int. Cl. G01N 30/30; G01N 30/60; G01N 30/72

(52) U.S. Cl. CPC G01N 30/30; G01N 30/6078; G01N 2030/285; G01N 2030/3061; G01N 30/7206

(57) ABSTRACT

A gas chromatography (GC) column system includes an insulation tubing, a metallic GC column disposed within the insulation tubing and having an outer diameter that is less than or equal to an inner diameter of the insulation tubing, a first electrode in contact with the metallic GC column, and a second electrode in contact with the metallic GC column on an opposite side of the insulation tubing from the first electrode. The metallic GC column may be heated by applying a voltage across the first and second electrodes. The voltage may be controlled in response to a measured temperature of the metallic GC column.

### CROSS-REFERENCE TO RELATED APPLICATIONS

This application relates to and claims the benefit of U.S. Provisional Application No. 62/511,768 filed May 26, 2017 and entitled “FAST TEMPERATURE RAMP GC SYSTEM,” the entire contents of which is hereby wholly incorporated by reference.

### STATEMENT RE: FEDERALLY SPONSORED RESEARCH/DEVELOPMENT

Not Applicable

### BACKGROUND

### 1. Technical Field

The present disclosure relates generally to the separation of chemicals in a sample using gas chromatography (GC) and, more particularly, to controlling the temperature of a GC column.

### 2. Related Art

Various devices for qualitative identification and/or quantitative measurement of chemicals in a sample make use of gas chromatography (GC) for separation of the sample into components. A vaporized sample passes through a GC column of a gas chromatograph in which different components of the sample are retained for different lengths of time depending on their chemical-physical properties. As each component elutes from the GC column, its retention time is measured by a detector. Chemical identification of each component is based on analysis of the measured retention time and the identified properties of the eluted component measured by the sensor technology of the detector.

In order to achieve adequate detector resolution both for chemical components that elute quickly from the GC column and for chemical components that elute slowly, temperature programming may be implemented. For example, the temperature of the GC column may be ramped during the run to increase the speed of elution later in the run. To this end, a conventional GC system uses a large oven to control the temperature of the GC column. The oven is normally a large thermally insulated oven that is heated electrically. Because of the large thermal mass of the oven, the GC column temperature can only be heated slowly, e.g. 5° C./min, which is not a desired limitation, especially for fast GC operation.

As an alternative to using an oven, Low Thermal Mass GC (LTMGC) has been developed as described in Luong, Jim et al,, “Low Thermal Mass Gas Chromatography: Principles and Applications,” Journal of Chromatographic Science, Volume 44, Issue 5, 1 May 2006, Pages 253-261 (“Luong”). According to Luong, LTMGC enables a GC column to be heated up at a ramp rate of up to 1800° C./min. The LTMGC column typically consists of a fused silica capillary column, a platinum resistive temperature detector (RTD), and a nickel alloy heating wire that are packed together and covered with a thin aluminum foil. Unfortunately, the size and overall complexity of currently commercialized LTMGC columns are not ideal for miniaturized GC systems.

Electronic Sensor Technology of Newbury Park, Calif. has developed a GC column based on resistive heating in which a metallic GC column is heated directly with electric current. The metallic GC column is coiled and the resulting planar coil is held by a high temperature insulation film to prevent electrical shorting between different parts of the column. While such a system may allow for fast temperature ramping and may be of relatively simple construction, the column is limited to about 1-2 meters long. When the column is longer than that, the structure of the system is unstable and can be damaged due to thermal expansion of the column.

### BRIEF SUMMARY

The present disclosure contemplates various systems and methods for overcoming the above drawbacks accompanying the related art. One aspect of the embodiments of the present disclosure is a gas chromatography (GC) column system. The GC column system includes an insulation tubing, a metallic GC column disposed within the insulation tubing and having an outer diameter that is less than or equal to an inner diameter of the insulation tubing, a first electrode in contact with the metallic GC column, and a second electrode in contact with the metallic GC column on an opposite side of the insulation tubing from the first electrode.

The GC column system may include a fan arranged to blow air toward the metallic GC column. The GC column system may include a thermoelectric cooler. The thermoelectric cooler may be arranged opposite the metallic GC column from the fan. The GC column system may include an enclosure containing the metallic GC column, the fan, and the thermoelectric cooler. The thermoelectric cooler may be arranged behind the fan such that air cooled by the thermoelectric cooler is blown toward the metallic GC column by the fan.

The metallic GC column may be coiled into a cylinder.

The metallic GC column may be coiled into a planar spiral.

The first electrode may be a first connector for connecting the metallic GC column to a first transfer line. The second electrode may be a second connector for connecting the metallic GC column to a second transfer line. The first and second transfer lines may be made of fused silica. The first connector may include a metallic ferrule for securing the first connector to the metallic GC column and a non-metallic ferrule for securing the first connector to the first transfer line. The second connector may include a metallic ferrule for securing the second connector to the metallic GC column and a non-metallic ferrule for securing the second connector to the second transfer line. The non-metallic ferrules of the first and second connectors may be graphite ferrules.

The GC column system may include a temperature sensor disposed within the insulation tubing between the first and second electrodes.

The metallic GC column may be a capillary column.

The insulation tubing may be made of polytetrafluoroethylene or polyimide. It can also be a layer of such insulation material directly painted or otherwise attached to the column.

The GC column system may include a power supply operable to apply a voltage across the first and second electrodes and a temperature controller operable to control an output of the power supply. The GC column system may include a temperature sensor disposed within the insulation tubing between the first and second electrodes. The temperature controller may be operable to control the output of the power supply in response to an output of the temperature sensor. The GC column system may include a thermoelectric cooler arranged to cool the metallic GC column. The temperature controller may be operable to control an output of the thermoelectric cooler.

Another aspect of the embodiments of the present disclosure is a method of heating a gas chromatography (GC) column. The method includes providing an insulation tubing, providing a metallic GC column disposed within the insulation tubing and having an outer diameter that is less than or equal to an inner diameter of the insulation tubing, providing a first electrode in contact with the metallic GC column, providing a second electrode in contact with the metallic GC column on an opposite side of the insulation tubing from the first electrode, and applying a voltage across the first and second electrodes.

Another aspect of the embodiments of the present disclosure is a method of controlling a temperature of a gas chromatography (GC) column. The method includes providing an insulation tubing, providing a metallic GC column disposed within the insulation tubing and having an outer diameter that is less than or equal to an inner diameter of the insulation tubing, providing a first electrode in contact with the metallic GC column, providing a second electrode in contact with the metallic GC column on an opposite side of the insulation tubing from the first electrode, applying a voltage across the first and second electrodes, measuring a temperature of the metallic GC column, and controlling the voltage in response to the measured temperature.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a simplified view of a system for controlling the temperature of a gas chromatography (GC) column according to an embodiment of the present disclosure;

FIG. 1A is an enlarged view of a region of the GC column, where it can be seen that the GC column is disposed within an insulation tubing;

FIG. 2 is an enlarged perspective view depicting a segment of the GC column and insulation tubing;

FIG. 3 is another simplified view of the system in one of various possible compact arrangements of the GC column;

FIG. 4 is another simplified view of the system in another of various possible compact arrangements of the GC column;

FIG. 5 is another simplified view of the system illustrating one of various possible cooling systems for cooling the GC column;

FIG. 6 is a simplified view of a system illustrating another of various possible cooling systems for cooling the GC column; and

FIG. 7 is a more detailed view of the system of FIGS. 1-5 illustrating functional relationships between the various aspects of the system described above.

### DETAILED DESCRIPTION

The present disclosure encompasses various embodiments of systems and methods for controlling the temperature of a gas chromatography (GC) column. The detailed description set forth, below in connection with the appended drawings is intended as a description of the several presently contemplated embodiments of these methods, and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

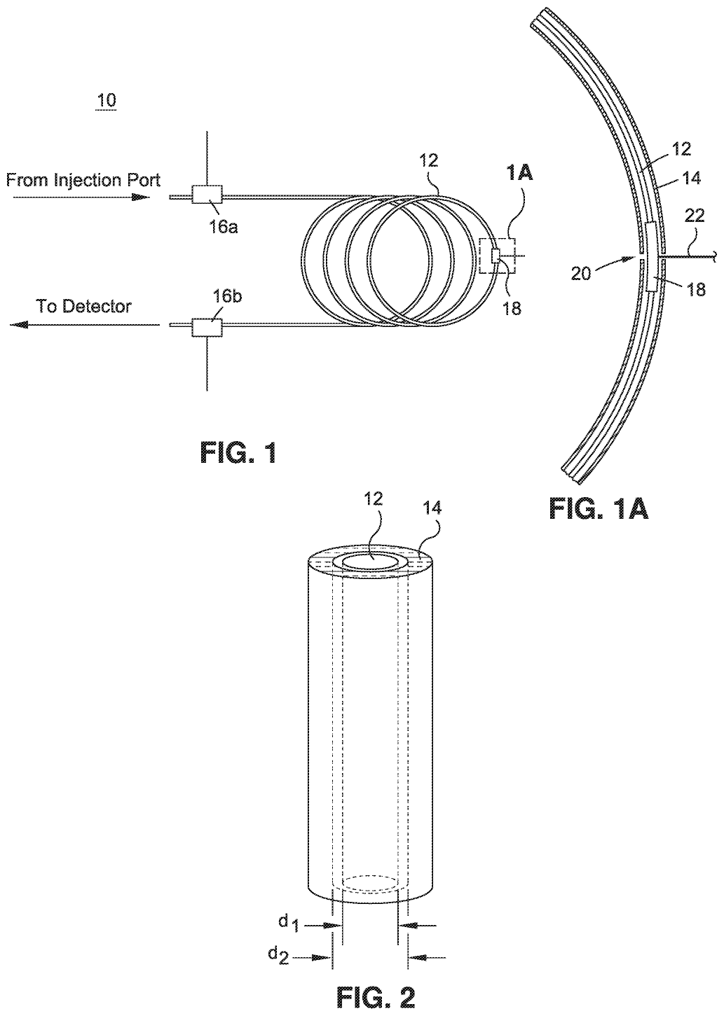

FIG. 1 is a simplified view of a system 10 for controlling the temperature of a gas chromatography (GC) column 12 according to an embodiment of the present disclosure. FIG. 1A is an enlarged view of a region of the GC column 12, where it can be seen that the GC column 12 is disposed within an insulation tubing 14. The GC column 12 is electrically conductive and may be a metallic GC column made of, for example, stainless steel. When a voltage is applied across first and second electrodes 16a, 16b in contact with the GC column 12, the resulting current conducted by the GC column 12 between the first and second electrodes 16a, 16b heats the GC column 12 as electrical energy is converted to thermal energy according to P=IV or P=I²R or P=V²/R, where P is the power dissipated by the GC column 12, I is the Current traveling through the GC column 12 between the first and second electrodes 16a, 16b, V is the voltage drop across the first and second electrodes 16a, 16b, and R is the resistance of the GC column 12 between the first and second electrodes 16a, 16b. By such a system 10, it may be possible to quickly ramp the temperature of the GC column 12 up and down according to the desired temperature programming, allowing for a faster analysis cycle than in the case of a conventional oven-heated system. Meanwhile, the insulation tubing 14 can prevent electrical shorting of the GC column 12 even though different parts of the insulation tubing 14 may contact each other as the GC column 12 is coiled or otherwise bent.

The system 10 may further include a temperature sensor 18 (e.g. a thermocouple) disposed within the insulation tubing 14 (e.g. in contact with the GC column 12) between the first and second electrodes 16a, 16b. One or more such temperature sensors 18 may be used to measure the temperature of the GC column 12, for example, at a middle point or at multiple points along the GC column 12. The measured temperature can then be fed back to control the temperature and/or temperature ramp rate of the GC column 12, for example, as an input for controlling the voltage applied across the first and second electrodes 16a, 16b.

As shown in FIG. 1A, the temperature sensor 18 may be disposed within the insulation tubing 14. In this regard, the insulation tubing 14 may be a single continuous piece of tubing or may comprise two (or more) pieces of tubing separated by a gap 20 as shown in FIG. 1A. In the case of two or more pieces of tubing, a temperature signal line 22 connected to the temperature sensor 18 may protrude from the insulation tubing 14 through the gap 20 (or the entire temperature sensor 18 itself may be disposed in the gap 20). In the case of a single continuous piece of tubing, the temperature signal line 22 may protrude from the insulation tubing 14 through a hole in the tubing. The insulation tubing 14 may be made of an electrically insulating material such as polytetrafluoroethylene (e.g. high temperature PTFE tubing) or polyimide (e.g. Kapton® tubing), preferably in the form of a thin walled tubing to allow the GC column 12 to be cooled down rapidly by cooling air from outside the insulation tubing 14.

FIG. 2 is an enlarged perspective view depicting a segment of the GC column 12 and insulation tubing 14. As shown, the GC column 12 may have an outer diameter d₁ that is less than an inner diameter d₂ of the insulation tubing 14. Owing to such clearance d₂−d₁, the GC column 12 has room to expand within the insulation tubing 14. In this way, as the GC column 12 is heated, thermal expansion of the GC column 12 can occur without damaging the insulation tubing 14. The clearance d₂−d₁ may be 0.05 mm or greater, preferably 0.10 mm or greater. For example, the outer diameter d₁ of the GC column 12 may be 0.41 mm and the inner diameter d₂ of the insulation tubing 14 may be 0.51 mm, such that the clearance d₂−d₁ is 0.10 mm. In the case that the insulation layer is directly painted on the column, d₂−d₁ is 0 mm. The insulation paint layer will expand and contract with the column. It should be noted that GC columns 12 and/or insulation tubing 14 without circular cross-section are also contemplated, in which case the clearance may be defined differently depending on the geometries of the GC column 12 and insulation tubing 14.

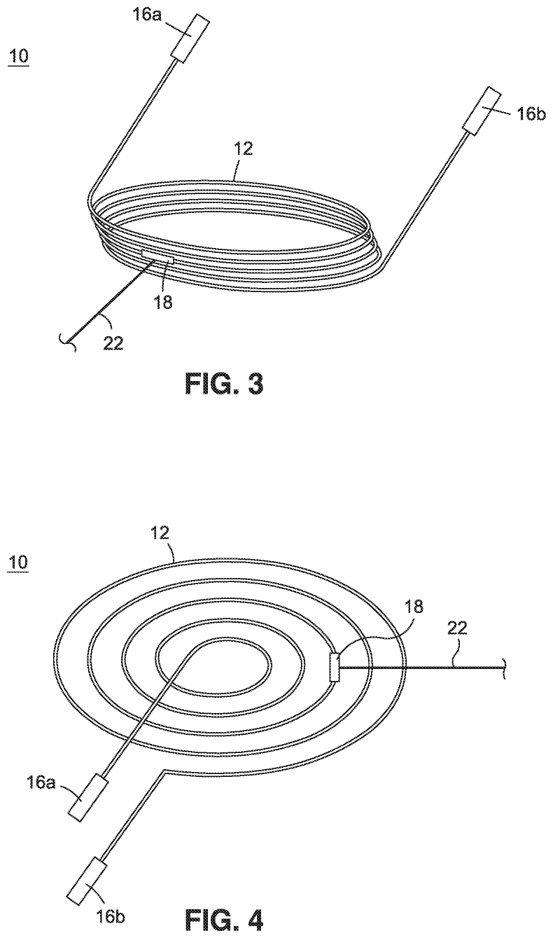

FIG. 3 is another simplified view of the system 10 in one of various possible compact arrangements of the GC column 12. In the example of FIG. 3, the GC column 12 is coiled into a cylinder (e.g. on a column cage). Such an arrangement of the GC column 12 may allow for faster cooling due to the large contact surface with cooling air, e.g. provided by a fan with cooling source, while avoiding sharp bending of the GC column 12. In general, the GC column 12 may be coiled into any desired shape that does not damage the stationary phase inside the GC column 12.

FIG. 4 is another simplified view of the system 10 in another of various possible compact arrangements of the GC column 12. In the example of FIG. 4, the GC column 12 is coiled into a planar spiral. Such an arrangement of the GC column 12 may allow for compactness while the use of the insulation tubing 14 allows for a greater degree of thermal expansion of the GC column 12 as compared to the Electronic Sensor Technology system in which an insulation film is needed for electrical insulation.

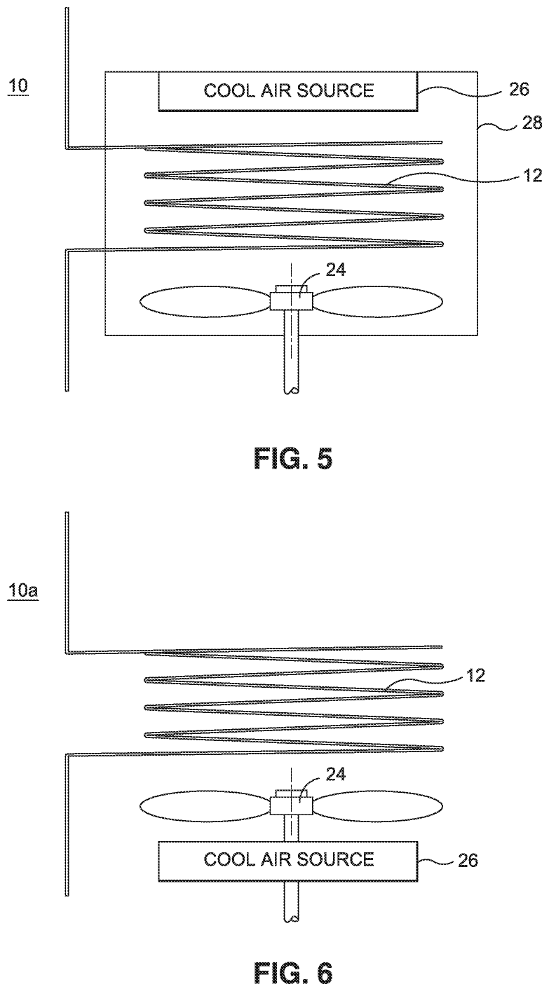

FIG. 5 is another simplified view of the system 10 illustrating one of various possible cooling systems for cooling the GC column 12. As shown in FIG. 5, the system 10 may include a fan 24 (e.g. an electric fan) arranged to blow air toward the GC column 12, a cool air source 26 such as a thermoelectric cooler, liquid nitrogen, etc., and an enclosure 28 containing the GC column 12 (e.g. a portion of the GC column 12 to be heated), the fan 24, and the cool air source 26. In cases where the GC column 12 is heated to temperatures greater than the ambient air temperature by resistive heating as described above, the fan 24 may cool the GC column 12 by blowing ambient air toward the GC column 12. By including a cool air source 26 arranged to cool the GC column 12, cooling to less than ambient temperature may further be achieved, thus increasing the retention time. This may allow highly volatile compounds that may not otherwise be detected due to very short retention time to be detected. Such cooling may also allow for faster cooling after each analysis to prepare for a subsequent run of the system 10 (e.g. to reach a temperature set point associated with a subsequent run) and may further be used to control temperature during a given run. For example, the fan 24 and/or cool air source 26 may be operated in conjunction with the electrodes 16a, 16b (not shown in FIG. 5) to lower or raise the temperature in response to feedback from the temperature sensor 18 (not shown in FIG. 5). The enclosure 28 may be a closed or semi-closed space in which cool air from the cool air source 26 may be circulated by operation of the fan 24 to provide even cooling of the GC column 12. The cool air source 26 may be arranged opposite the GC column 12 from the fan 24 or anywhere else within the enclosure 28, such as on a side wall of the enclosure 28 relative to the fan 24.

FIG. 6 is a simplified view of a system 10a illustrating another of various possible cooling systems far cooling the GC column 12. The system 10a may be the same as the system 10 described in relation to FIGS. 1-5 except for the following difference in the arrangement of the cooling system. Whereas the system 10 includes an enclosure 28 containing the GC column 12, the fan 24, and the cool air source 26, the enclosure 28 is omitted in the system 10a and the cool air source 26 is arranged behind the fan 24 such that air cooled by the cool air source 26 is blown toward the GC column 12 by the fan 24. With the cool air source 26 arranged behind the fan 24 in this way, the cool air may simply be directed toward the GC column 12 rather than circulated within an enclosure 28.

The cooling systems of FIGS. 5 and 6 are only provided by way of example and it should be recognized that various other arrangements are possible as well. For example, if it is unnecessary to cool the GC column 12 to temperatures less than ambient, the cool air source 26 may be completely omitted. It is also contemplated that the enclosure 28 may include an opening or other heat sink for allowing hot air from the enclosure 28 to escape, especially in cases where the cool air source 26 is omitted.

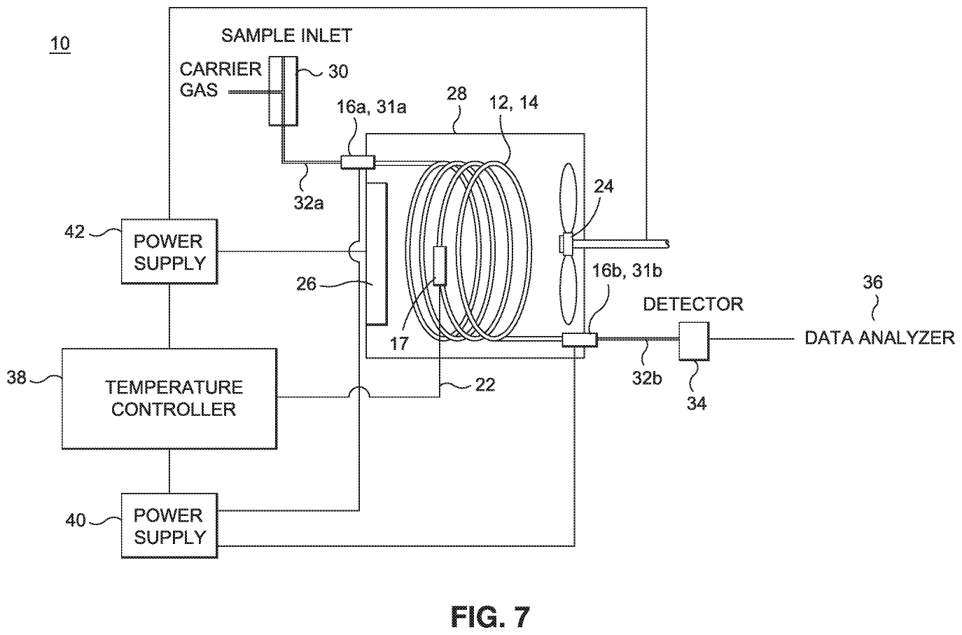

FIG. 7 is a more detailed view of the system 10 of FIGS. 1-5 illustrating functional relationships between the various aspects of the system 10 described above. In addition to the GC column 12, insulation tubing 14 (which may comprise separate pieces of tubing separated by one or more gaps 20), electrodes 16a, 16b, temperature sensor 18, temperature signal line 22, fan 24, cool air source 26, and enclosure 28, the system 10 may further include a sample inlet 30 (e.g. an injection port), input transfer line 32a, output transfer line 32b, detector 34, and data analyzer 36, along with a temperature controller 38, a heating power supply 40, and a cooling power supply 42.

Upon being injected into the system 10 via the sample inlet 30 (e.g. via syringe injection, thermal desorption, etc.), a vaporized sample may be carried by a carrier gas through the input transfer line 32a, the GC column 12, and the output transfer line 32b to the detector 34, where retention time and other properties (e.g. mass) may be measured, depending on the type of detector 34 used. Example detectors 34 include mass spectrometers as used in GC/mass spectrometry (MS) systems, photoionization detectors (PID), flame ionization detectors, electron capture detectors (ECD), surface acoustic wave (SAW) sensors as used in GC/SAW systems, and Raman spectrometers, as well as combinations thereof. In this regard, one possible contemplated detector 34 uses a combined SAW sensor and Raman spectrometer system as described in International Patent Application Pub. No. WO 2017/201250 entitled “Identification of Chemicals in a Sample Using GC/SAW and Raman Spectroscopy” (“the '250 publication”), the entire contents of which is hereby wholly incorporated by reference. Measurement results of the detector 34 may be used for qualitative and/or quantitative analysis of the sample by the data analyzer 36, which may be operatively connected to the detector 34 by a physical (e.g. wired) connection, a wireless connection over a network, or a purely conceptual connection such as in a case where data generated by the detector 34 is then accessed, processed, etc. by the data analyzer 36 (e.g. after being transferred by some data storage medium). Examples of the data analyzer 36 are the apparatus 200 of the '250 publication and the apparatus 200 of U.S. Patent Application Pub. No. 2018/0024100 entitled “Temperature Control for Surface Acoustic Wave Sensor,” the entire contents of which is hereby wholly incorporated by reference.

The GC column 12 may be a metallic column as described above, electrically insulated by the insulation tubing 14 and heated by resistive heating through application of a voltage to the first and second electrodes 16a, 16b. In this regard, the first electrode 16a may be M contact with the GC column 12 on one side of the insulation tubing 14 and the second electrode 16b may be in contact with the GC column 12 on an opposite side of the insulation tubing 14 from the first electrode 16a. Whereas the GC column 12 is electrically conductive and may be a metallic GC column for the purpose of resistive heating, the input and output transfer lines 32a, 32b may be made of fused silica. The first electrode 16a may be an input connector 31a for connecting the GC column 12 to the input transfer line 32a, and the second electrode 16b may be an output connector 31b for connecting the GC column 12 to the output transfer line 32b. For example, the input connector 31a may include a metallic ferrule for securing the input connector 31a to the GC column 12 and a non-metallic ferrule (e.g. a graphite ferrule) for securing the input connector 31a to the input transfer line 32a. Similarly, the output connector 31b may include a metallic ferrule for securing the output connector 31b to the GC column 12 and a non-metallic ferrule (e.g. a graphite ferrule) for securing the output connector 31b to the output transfer line 32b. According to such an implementation, the voltage applied across the first and second electrodes 16a, 16b to heat the GC column 12 may be applied across the metallic ferrules of the input and output connectors 31a, 31b. The electric current can thus only pass through and heat up the GC column 12 between the connectors 31a, 31b, as the non-metallic ferrules of the connectors 31a, 31b act as electrical insulators. An example connector that may be used as the input connector 31a and/or output connector 31b is a zero dead volume GC column connector having custom-made and/or standard commercially available ferrules. For example, the metallic ferrules may be made from annealed 304 stainless steel and may have an inner diameter of 0.020″ and a length of 0.150″, and the non-metallic ferrules may be 1/32″ valcon polyimide adapter/ferrules for tubing having an outer diameter of 0.36-0.40 mm as provided by Vici Valco Instruments.

As shown in FIG. 7, the portion of the GC column 12 heated by the first and second electrodes 16a, 16b (e.g. the portion between the electrodes 16a, 16b) may be the same portion of the GC column 12 that is enclosed in the enclosure 28, such that the entire heated portion may be subject to the cooling system of FIG. 5. For example, within the enclosure 28, the GC column 12 may be coiled as shown in FIG. 3 or 4 and disposed between the fan 24 and cool air source 26, with the first and second electrodes 16a, 16h (e.g. the input and output connectors 31a, 31b) disposed at or near the walls of the enclosure 28 (e.g. protruding through the walls of the enclosure 28). It is also contemplated that the enclosure 28 may be omitted as in the example of the system 10a of FIG. 6. In this case, the GC column 12 may be coiled in a cool air region in front of the fan 24 and cool air source 26, with the first and second electrodes 16a, 16b (e.g. the input and output connectors 31a, 31b) disposed at or near the borders of the cool air region.

The heating power supply 40 may apply a voltage across the first and second electrodes 16a, 16b to heat the GC column 12. The temperature controller 38 may control the output of the heating power supply 40. Such control may include commands for turning on and off the applied voltage and may further include commands for adjusting the amount of voltage and/or current in order to increase or decrease the amount of power dissipated by the GC column 12 between the first and second electrodes 16a, 16b. The temperature controller 38 may similarly control the output of the fan 24 and/or cool air source 26. For example, power to operate the fan 24 and/or cool air source 26 may be provided by the cooling power supply 42, whose output may be controlled by the temperature controller 38.

As described above, the system 10 may include one or more temperature sensors 18 (e.g. thermocouples) disposed within the insulation tubing 14 (e.g. in contact with the GC column 12) between the first and second electrodes 16a, 16b. The temperature controller 38 may control the output of the heating power supply 40 and/or the cooling power supply 42 in response to an output of the one or more temperature sensors 18. For example, the temperature controller 38 may receive a temperature signal via a temperature signal line(s) 22 connected to the temperature sensor(s) 18. The temperature signal may indicate a current temperature of the GC column 12 as measured by the temperature sensor(s) 18. On the basis of such temperature signal, the temperature controller 38 may control the output of the power supply 40 and/or the power supply 42. In this way, the temperature controller 38 may control the voltage applied across the first and second electrodes 16a, 16b (and may further control outputs of the fan 24 and/or cool air source 26) in response to the temperature measured by the temperature sensor(s) 18. For example, the temperature controller 38 may include a proportional-integral-derivative controller or other feedback mechanism to appropriately control the outputs of the power supplies 40, 42 such that the temperature of the GC column 12 (as measured by the temperature sensor 18) is maintained at a desired set point. The set point may be a time-varying set point (e.g. a temperature ramp) in accordance with a desired temperature program and may include, for example, an initial temperature, a holding time, a temperature ramp rate, a maximum temperature, another holding time, etc. Such set point for the column temperature may be one of several instrument conditions further including carrier gas flow rate, inject temperature, sensor conditions, etc. defining the conditions of an analysis run.

In the example of FIG. 7, a cooling power supply 42 controls the fan 24 and/or cool air source 26 under the control of the temperature controller 38. However, it is also contemplated that the temperature controller 38 may control the output of the fan 24 and/or cool air source 26 directly without controlling power inputs thereof. In this case, the temperature controller 38 may be separately connected to the fan 24 and/or cool air source 26 and may not be connected to the cooling power supply 42.

As noted above with respect to FIG. 7, the enclosure 28 may be omitted as in the example of the system 10a of FIG. 6. In this regard, it is contemplated that the system 10a may otherwise have all of the features shown and described with respect to the system 10 of FIG. 7.

The temperature controller 38, as well as the data analyzer 36 and other elements of the system 10, 10a, may be wholly or partly embodied in program instructions (e.g. software) stored on a program storage medium and executable by a processor or programmable circuitry. Various user interface devices (e.g. keyboard and mouse, display, etc.) may be functionally connected therewith (e.g. locally or via a network connection) and used for temperature programming and data analysis.

In the examples described above, the temperature sensor 18 is described as being within the insulation tubing 14. However, the disclosure is not intended to be so limited and in some eases the temperature sensor 18 may be positioned outside the insulation tubing 14. For example, the temperature sensor 18 may be disposed on an outer surface of the insulation tubing 14 or at a position removed from the GC column 12 and insulation tubing 14, e.g. nearby within the enclosure 28, depending on the accuracy with which the temperature of the GC column 12 is to be controlled. In this regard, it should be noted that the temperature sensor 18 may be completely omitted in some cases.

The GC column 12 described throughout this disclosure is preferably a capillary column of any size. However, the disclosure is not intended to be so limited and the GC column 12 may instead be a packed column.

For applications that require the analysis of very small molecules or highly volatile chemicals, such as small Volatile Organic Compounds (VOCs) in environmental samples and breath samples, it may be necessary to perform GC at a low temperature in order to prevent the small chemicals from eluting out too early, before the start of the temperature ramp. Meanwhile, it may be necessary for the temperature ramp to include higher temperatures so that less volatile chemicals can be separated through the column. By using resistive heating to rapidly ramp the temperature. the system 10, 10a described throughout this disclosure may make it possible to achieve this combination of functions in a miniaturized system without needing to purchase additional high cost add-ons such as Agilent's 5975T LTM Column Module or CO₂ cryogenic cooling system. Meanwhile, by virtue of the insulation tubing 14, the system 10, 10a may effectively heat a long GC column 12 (e.g. longer than 2 meters) without the risk that thermal expansion or contraction of the GC column 12 may damage the structure of the system 10, 10a, as may occur in the case of the insulation film of the system developed by Electronic Sensor Technology. With the addition of simple cooling systems as described above, the system 10, 10a may further be operated at temperatures lower than ambient temperature for separating and analyzing highly volatile chemicals.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

1. A gas chromatography (GC) column system comprising:
an insulation tubing;
a metallic GC column disposed within the insulation tubing and having an outer diameter that is less than or equal to an inner diameter of the insulation tubing;
a first electrode in contact with the metallic GC column; and
a second electrode in contact with the metallic GC column on an opposite side of the insulation tubing from the first electrode.

2-20. (canceled)
